(19) United States
(12) Patent Application Publication
(10) Pub. No.: US 2013/0276072 A1
(43) Pub. Date: Oct. 17, 2013

(54) Method for Enabling Exchange of User Profiles Between a Visited Network and a Home Network

(71) Applicants: Mona Matti, Nacka (SE); Tor Kvernvik, Taby (SE); Mattias Lidström, Stockholm (SE)

(72) Inventors: Mona Matti, Nacka (SE); Tor Kvernvik, Taby (SE); Mattias Lidström, Stockholm (SE)

(73) Assignee: TELEFONAKTIEBOLAGET L M ERICSSON (PUBL), Stockholm (SE)

(21) Appl. No.: 13/995,407

(22) PCT Filed: Dec. 21, 2010
(86) PCT No.: PCT/SE2010/051447

§ 371 Date: Jun. 18, 2013

(51) Int. Cl. H04L 29/06

(52) U.S. Cl. CPC H04L 63/0281
USPC 726/4; 726/12

(57) ABSTRACT

The invention relates to a method (40) in a visited gateway server (21) in a communication system (1) comprising a home network (10) and a visited network (20) for enabling exchange of user profiles between a visited user profile server (22) of the visited network (20) and a home user profile server (12) of the home network (10), the method comprising: receiving (41) a user identification from a user equipment (2) requesting access to the visited network (20); transmitting (42), in response to received user identification, an identifier of the visited user profile server (22) to the user equipment (2) for conveyance by the user equipment (2) to the home user profile server (12), thereby enabling the exchange of user profiles. The invention also relates to visited gateway server, methods in a visited user profile server, visited user profile server, and methods in a user equipment, user equipment and computer programs.

### FIELD OF THE INVENTION

The invention relates to devices and methods for enabling exchange of user profiles between a visited user profile server of the visited network and a home user profile server of the home network.

### BACKGROUND OF THE INVENTION

In today's dynamic business environment it is important for an operator of a communication system to have as much information about their subscribers as possible. The operator is thereby able to offer the subscribers more personalized and thus more valuable services. The subscribers can be provided with nearly unlimited choices for services, tailored to their unique personalities, preferences and lifestyles.

Today, some difficulties are encountered when acquiring information about specific subscribers, in the following also denoted users. Many of the techniques used for deriving user preferences are based on user representation in a declarative and static way. However, in today's environment, user context often changes, which necessitates the need to adapt the services being used by the user in accordance with his/hers current context. An effort to improve this static user knowledge comprises using machine learning algorithms, which is a more advanced technique for depicting user preferences.

The gathering/acquisition of information about specific subscribers entails also another difficult aspect: the integrity of the subscriber. User preferences are stored in user profiles and in order to maintain personal privacy a separate user profile may for example be kept for an identity in a specific user context. This not only ensures protection of the information but also allows the user to have different preferences for different contexts.

A user roaming between different communication networks is preferably provided services suited for his current context. For example, if the user is on vacation in a particular country, he may prefer and need different services than if he is on a work journey. Today, the user accessing services in a first communication network or a first location is not able to continue to use those equivalent services without interruption when moving to a new location or different communication network, even provided the service is accessible at this new location.

Existing user profile management systems offer up-to-the-minute information about one single subscriber view, including updates to the subscriber's profile. Each operator domain persists in using their particular user profile solution in order to enable them to consolidate and/or federate real-time information such as data in their home location register (HLR), home subscriber server (HSS) or in multiple database types across their communication network. There is a need for providing personalized user preferences even when the user is moving across boundaries of different communication networks and meeting the user's current needs and demands without provoking privacy.

In “Service Invocation and Roaming in Pervasive-Computing Environments” by Alvin Yung Chian Chin, a framework is developed for a service paradigm that facilitates a user to perform a particular task to get access to services in a seamless manner, tailored to their preferences and to the location that they are in. However, the document fails to consider roaming scenarios.

A challenge thus comprises how to find a unified, manageable, consistent user preference or user profile across boundaries of different operator's communication networks, without increasing the operational costs and without compromising the user privacy. It is clear that there is a need for improvements in this regards.

### SUMMARY OF THE INVENTION

It is an object of the invention to enable subscribers of a communication network to obtain tailored services even when roaming, with maintained user integrity.

The object is according to a first aspect of the invention achieved by a method in a visited gateway server in a communication system. The communication system comprises a home network and a visited network for enabling exchange of user profiles between a visited user profile server of the visited network and a home user profile server of the home network. The method comprises receiving a user identification from a user equipment requesting access to the visited network; transmitting, in response to received user identification, an identifier of the visited user profile server to the user equipment for conveyance by the user equipment to the home user profile server, thereby enabling the exchange of user profiles.

By enabling the exchange of user profiles between the home network and the visited network, services provided to a user may be adapted in accordance with the user's context information associated with his/hers current identity and/or location. The exchange of user profiles enables an adaptation of the services provided to the user, who thereby is able to get tailored services when roaming within the communication system.

In one embodiment, the method comprises transmitting the identifier of the visited user profile server to an authentication, authorization and accounting proxy of the visited network. The proxy is thereby able to convey the identifier of the visited user profile server to an authentication, authorization and accounting server of the home network.

In one embodiment, the step of receiving user identification from the user equipment is performed during a procedure for initiating, by the user equipment, a new access to the visiting network.

In one embodiment, the identifier of the visited user profile server comprises a unique identifier pointing to the visited user profile server.

The unique identifier may for instance comprise a domain name address or Internet protocol address.

The object is according to a second aspect of the invention achieved by a visited gateway server in a communication system comprising a home network and a visited network for enabling exchange of user profiles between a visited user profile server of the visited network and a home user profile server of the home network. The visited gateway server comprises receiving circuitry for receiving user identification from a user equipment, and transmitting circuitry. The visited gateway server is configured to transmit, by means of the transmitting circuitry, an identifier of the visited user profile server to the user equipment in response to receiving, by means of the receiving circuitry, the user identification, for conveyance by the user equipment to the home user profile server. Thereby the visited user profile server and the home user profile server are able to initiate user profiles exchange.

The object is according to a third aspect of the invention achieved by a computer program for enabling, in a communication system comprising a home network and a visited network, exchange of user profiles between a visited user profile server of the visited network and a home user profile server of the home network. The computer program comprises computer program code which, when run on a visited gateway server of the visited network, causes the visited gateway server to: receive a user identification from a user equipment requesting access to the visited network; transmit, in response to receiving the user identification, an identifier of the visited user profile server to the user equipment for conveyance by the user equipment to the home user profile server, whereby the visited user profile server and the home user profile server are able to exchange user profiles.

In one embodiment, a computer program product is provided. The computer program product comprises the computer program and a computer readable means on which the computer program is stored.

The object is according to a fourth aspect of the invention achieved by a method in a visited user profile server of a communication system comprising a home network and a visited network for enabling exchange of user profiles between a home user profile server of the home network and a visited user profile server of the visited network. The method comprises: receiving from the home user profile server a user profile for a user visiting the visited network; creating a temporary user profile for the user based on the received user profile; receiving new user profile preferences for the user obtained while the user roams in the visited network; and updating the temporary user profile with the new user profile preferences.

The received user profile may for instance be based on one or more of: a pre-configured policy, a service level agreement between the home network and the visited network, user profile information allowed by the user and/or subscription data of the user.

In one embodiment, the method comprises the further steps of: receiving a close connection message; updating, in response to the close connection message, the temporary user profile in the visited user profile server, the updating comprising new user profile preferences; transmitting to the home user profile server the updated user profile.

In a variation of the above embodiment the method comprises the step of, after transmitting to the home user profile server the updated user profile, deleting in the visited user profile server the temporary user profile for the user.

The object is according to a fifth aspect of the invention achieved by visited user profile server of a communication system comprising a home network and a visited network for enabling exchange of user profile preferences between a home user profile server of the home network and a visited user profile server of the visited network, the visited user profile server comprising: first receiving circuitry configured to receive from the home user profile server a user profile for a user visiting the visited network; first processing circuitry configured to create a temporary user profile for the user based on the user profile received by means of the first receiving circuitry; and second processing circuitry configured to update the temporary user profile with new user profile preferences obtained while the user equipment roams in the visited network.

In one embodiment, the visited user profile server further comprises: second receiving circuitry configured to receive a close connection message; third processing circuitry configured to update the temporary user profile in the visited user profile server, the updating comprising new user profile preferences; first transmitting circuitry configured to transmit to the home user profile server the updated user profile.

The object is according to a sixth aspect of the invention achieved by computer program for enabling, in a communication system comprising a home network and a visited network, exchange of user profiles between a visited user profile server of the visited network and a home user profile server of the home network, the computer program comprising computer program code which, when run on the visited user profile server of the visited network, causes the visited user profile server to: receive from the home user profile server a user profile for a user visiting the visited network; create a temporary user profile for the user based on the received user profile; and update the temporary user profile with new user profile preferences obtained while the user roams in the visited network.

In one embodiment, the computer program further comprises computer program code which, when run on the visited user profile server of the visited network, causes the visited user profile server to: receive a close connection message; update the temporary user profile in the visited user profile server, the updating comprising latest user profile preferences; and transmit to the home user profile server the updated user profile.

In one embodiment, computer program product is provided comprising the computer program and computer readable means on which the computer program is stored.

The object is according to a seventh aspect of the invention achieved by a method in a user equipment of a communication system comprising a home network and a visited network for enabling exchange of user profiles between a home user profile server of the home network and a visited user profile server of the visited network. The method comprises: requesting access to the visited network; receiving, in response to the request, from a visited gateway server of the visited network, an identifier of a visited user profile server; and conveying the identifier of the visited user profile server to the home user profile server.

In one embodiment, the step of conveying the identifier of the visited user profile server comprises: performing a mobile internet protocol, MIP, registration or binding; adding in the MIP registration or binding an identifier of the visited user profile server; and conveying the identifier of the visited user profile server to the home user profile server.

In one embodiment, the step of conveying the identifier of the visited user profile server comprises adding in a registration or binding request message the identifier of the visited user profile server. The method is thus applicable in communication systems using different versions of internet protocols, e.g. IPv4 or IPv6.

In one embodiment, the identifier of the visited user profile server comprises a unique identifier pointing to the visited user profile server.

The unique identifier may for instance comprise a domain name address or Internet protocol address.

The object is according to a eighth aspect of the invention achieved by user equipment of a communication system comprising a home network and a visited network for enabling exchange of user profiles between a home user profile server of the home network and a visited user profile server of the visited network. The user equipment comprises a first processor configured to: request access to the visited network utilizing access circuitry; receive, by means of first receiving circuitry and in response to the request, from a visited gateway server of the visited network, an identifier of a visited user profile server; and convey, using first transmitting circuitry, the identifier of the visited user profile server to the home user profile server.

The object is according to a ninth aspect of the invention achieved by a computer program for enabling, in a communication system comprising a home network and a visited network, exchange of user profiles between a visited user profile server of the visited network and a home user profile server of the home network, exchange of user profiles between a visited user profile server of the visited network and a home user profile server of the home network, the computer program comprising computer program code which, when run on a user equipment, causes the user equipment to: request access to the visited network; receive, in response to said request, from a visited gateway server of the visited network, an identifier of a visited user profile server; and convey the identifier of the visited user profile server to the home user profile server.

In one embodiment, a computer program product is provided comprising a computer program computer readable means on which the computer program is stored.

Further features and advantages thereof will become clear upon reading the following description and the accompanying drawings.

### BRIEF DESCRIPTION OF THE DRAWINGS

FIG. 1 illustrates schematically an environment in which the present invention can be applied.

FIG. 2 illustrates schematically devices involved in a roaming scenario and communication paths between the devices.

FIG. 3 is a sequence diagram illustrating communication between entities of FIG. 2 at access request.

FIG. 4 is a sequence diagram illustrating communication between entities of FIG. 2 at termination of access.

FIG. 5a illustrates a visited gateway server.

FIG. 5b illustrates computer program and computer program product for the visited gateway server of FIG. 5a.

FIG. 6a illustrates a user equipment.

FIG. 6b illustrates computer program and computer program product for the user equipment of FIG. 6a.

FIG. 7a illustrates a visited user profile server.

FIG. 7b illustrates computer program and computer program product for the visited user profile server of FIG. 7a.

FIG. 8 is a flow chart over steps in a method in a visited gateway server.

FIG. 9 is a flow chart over steps in the method of FIG. 8 in accordance with one embodiment.

FIG. 10 is a flow chart over steps in a method in a visited user profile server.

FIG. 11 is a flow chart over steps in the method of FIG. 10 in accordance with one embodiment.

FIG. 12 is a flow chart over steps in the method of FIG. 10 in accordance with one embodiment.

FIG. 13 is a flow chart over steps in a method in user equipment.

FIG. 14 is a flow chart over steps in the method of FIG. 13 in accordance with one embodiment.

### DETAILED DESCRIPTION OF EMBODIMENTS OF THE INVENTION

In the following description, for purposes of explanation and not limitation, specific details are set forth such as particular architectures, interfaces, techniques, etc. in order to provide a thorough understanding of the invention. However, it will be apparent to those skilled in the art that the invention may be practiced in other embodiments that depart from these specific details. In other instances, detailed descriptions of well-known devices, circuits, and methods are omitted so as not to obscure the description of the invention with unnecessary detail. Like numbers refer to like elements throughout the description.

In the following, user and subscriber are used interchangeably for denoting a user of a user equipment for which a subscription for communication services has been signed with an operator of a communication system.

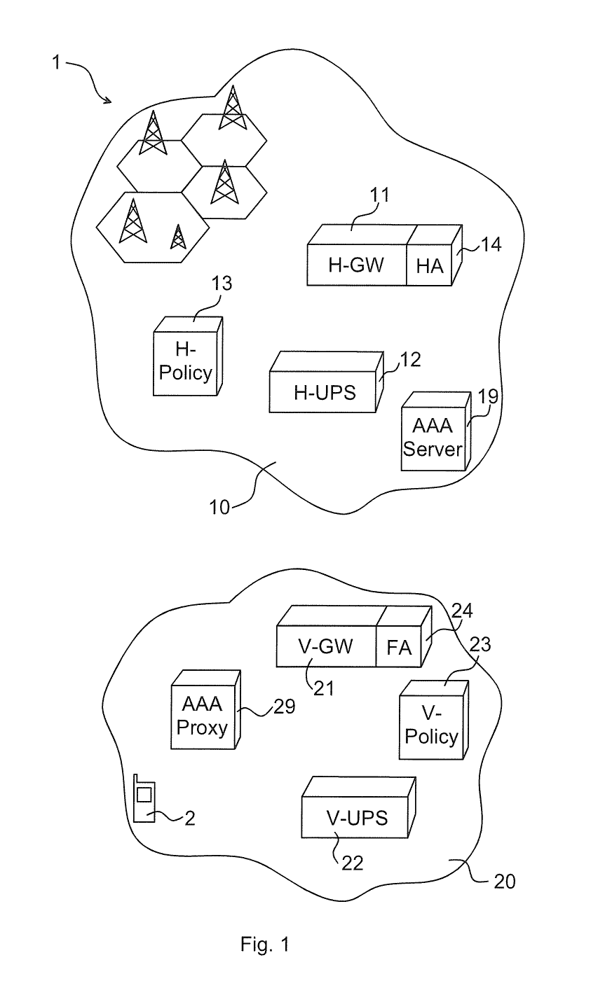

FIG. 1 illustrates schematically an environment in which the present invention can be applied. A communication system 1, which may for instance comprise a system conforming to LTE Advanced standard, comprises the communication networks of at least a first and a second service provider, also denoted operator. In the following description such first and second service providers' communication networks are denoted home network 10 and visited network 20, respectively. The service provider of the home network 10 and the service provider of the visited network 20 have service level agreements (SLA) them between, and other preconfigured policies, covering information ownership, access policies, who are allowed to store information, access and forward such context etc. The subscriber's consensus to share his/her preferences is further presupposed. The subscriber may have allowed his/her home network 10 to share to the visited network 20 all or only a subset of the preferences available in the home network 10.

The home network 10 comprises a home policy server 13, and the visited network 20 comprises a visited policy server 23. The policy server 13, 23 is a security component based on policy control technology that provides authorization services and facilitates tracking and control of among other profile sharing policies authorization. The policy server 13, 23 accepts user profile sharing requests, processes them against a formal set of statements that define how such profiles are to be allocated among its requesters.

The home network 10 and the visited network 20 both comprise a respective user profile server, denoted home user profile server 12 in the home network 10 and visited user profile server 22 in the visited network 20. The user profile servers 12, 22 may have their own mechanisms for obtaining user preferences or user profiles. Machine learning algorithms may for instance be to this end. The user profile servers 12, 22 creates and store short term and long term user profiles depending on an analysis of data regarding the user such as subscription database, network nodes, location etc. The user profile server, or user profile engine UPE, as such is subject of a co-pending patent application, assigned to the same Applicant as the present application.

The home network 10 comprises a home gateway 11 and home agent 14 in conventional manner. Likewise, the visited network 20 comprises a visited gateway 21 and foreign agent 24. The home network 10 further comprises an authentication, authorization and accounting (AAA) server 19, whereas the visited network 20 correspondingly comprises an AAA proxy 29. Conventionally, the service providers apply some security procedure before accessing services, which procedures are performed in the AAA server 19 and AAA proxy 29, respectively.

A subscriber having a user equipment 2 has a subscription with the service provider of the home network 10, and is able to roam to the visited network 20 by means of which another service provider provides services. The home network 10 and the visited network 20 have roaming agreements and, as mentioned earlier, possibly other agreements defining the user profile exchange or sharing.

Picture a scenario wherein the visited network 20 wants to e.g. push some advertisements to the subscriber roaming therein. In order to decide when and what to be pushed for advertisements to the subscriber, the visited network 20 would like to know more about the subscriber. However, the visited network 20 has no access to the traffic data or other subscription data that could be analyzed in order to find a profile best describing the subscriber. The visited network 20 needs a user profile containing the latest user context.

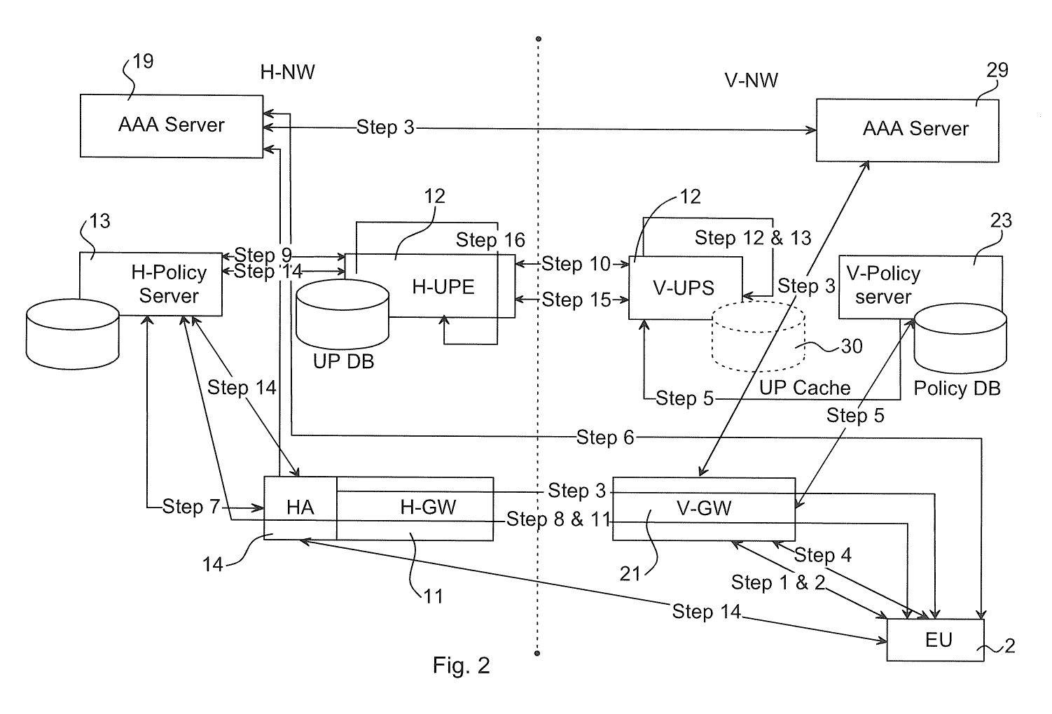

FIG. 2 illustrates schematically devices involved in a roaming scenario and communication between the devices. A vertical, dashed line indicates a border between devices of the home network 10 (left hand side) and devices of the visited network 20 (right hand side). Arrows in the FIG. 2 are denoted with “step” and a number, and for example the denotation “step 3” corresponds to “at arrow 3” in the following.

At arrow 1, upon attachment to a new access, the user equipment 2 starts an association or discovery and handshaking procedure toward an authentication agent or authenticator, e.g. the foreign agent 24, in the visited gateway server 21.

At arrow 2, the discovery procedure for the AAA proxy 29 in the visited network 20 is performed.

At arrow 3, the access authentication procedure is carried on without any information concerning the discovery of policy server 23 or the visited user profile server 22. The steps indicated at arrows 1, 2 and 3 are known procedures and are therefore not described in any detail.

At arrow 4, a dynamic host configuration protocol (DHCP) for a local IP (Internet Protocol) address is run, which is an auto-configuration protocol used on IP networks. The user equipment 2 is configured with an identifier, e.g. an address, to the visited user profile server 22, which is done in dependence on the assigned IP address.

At arrow 5, an IP session setup request is sent to the visited policy server 23. The visited policy server 23 forwards the request to the visited user profile server 22.

At arrow 6, an IP security is run between the user equipment 2 and the AAA server 19 and the home agent 14 is assigned and the home agent 14 is included amongst other information in the IP security signaling.

At arrow 7, the home gateway server 11, which holds the home agent 14 for the user, assigns a home IP address and sends an IP session setup request to the home policy server 13.

At arrow 8, the user equipment 2 starts an MIP binding update request (for IPv6) or MIP registration request (for IPv4) to the home agent 14 including the identifier, e.g. address, to the visited user profile server 22, wherein the home agent 14 sends update request to the home policy server 13.

At arrow 9, the home policy server 13 informs the home user profile server 12 about the visited user profile server 22 information. For the interaction between the home policy server 13 and the home user profile server 12, for instance security assertion markup language (SAML) as an XML-based framework for communicating user authentication, entitlement and attribute information can be used with XCAML.

At arrow 10, the home user profile server 12 initiates interaction with the visited user profile server 22 for pushing user profile according to specific authorized policies in the related home policy server 13. The interface between the two user profile servers 12, 22 to expose the user profile can use for example the Standard Semantic Web (RDF/OWL). The home user profile server 12 then sends notification to the home policy server 13, which sends an answer to the home gateway server 11.

At arrow 11, the home gateway server 11 sends MIP acknowledgment or answer to the user equipment 2.

At arrow 12, the visited user profile engine 22 creates a temporary user profile, in the following denoted short term profile, for the user based on a default user profile that it received from the home user profile server 12. This short term profile is stored in a cache memory 30 or the like as long as the user is roaming in the visited network 20. This short term profile can be stored in the visited network 20 if this is agreed upon, e.g. in a business SLA agreement.

At arrow 13, the visited user profile server 22 will update the short term profile according to new preferences that the user gains while roaming the visited network 20.

At arrow 14, when the user leaves the visited network 20, the home agent server 13 receives a termination request, which will be forwarded to the home user profile server 12 via the home policy server 13.

At arrow 15, the home user profile server 12 sends a close connection message to the visited user profile server 22, expecting an answer in return with the latest update made to the short term profile. The visited user profile server 22 sends an acknowledge close connection message to the home user profile server 12 with the latest user profile for the user.

Finally, at arrow 16, the home user profile server 12 will update a user profile database 31 with the latest update.

Above, an embodiment of the invention has been described. The invention is however not restricted to this scenario. The user profile servers 12, 22 can be used for interacting with other service providers, e.g. a 3^{rd} party service provider, requesting the user profile.

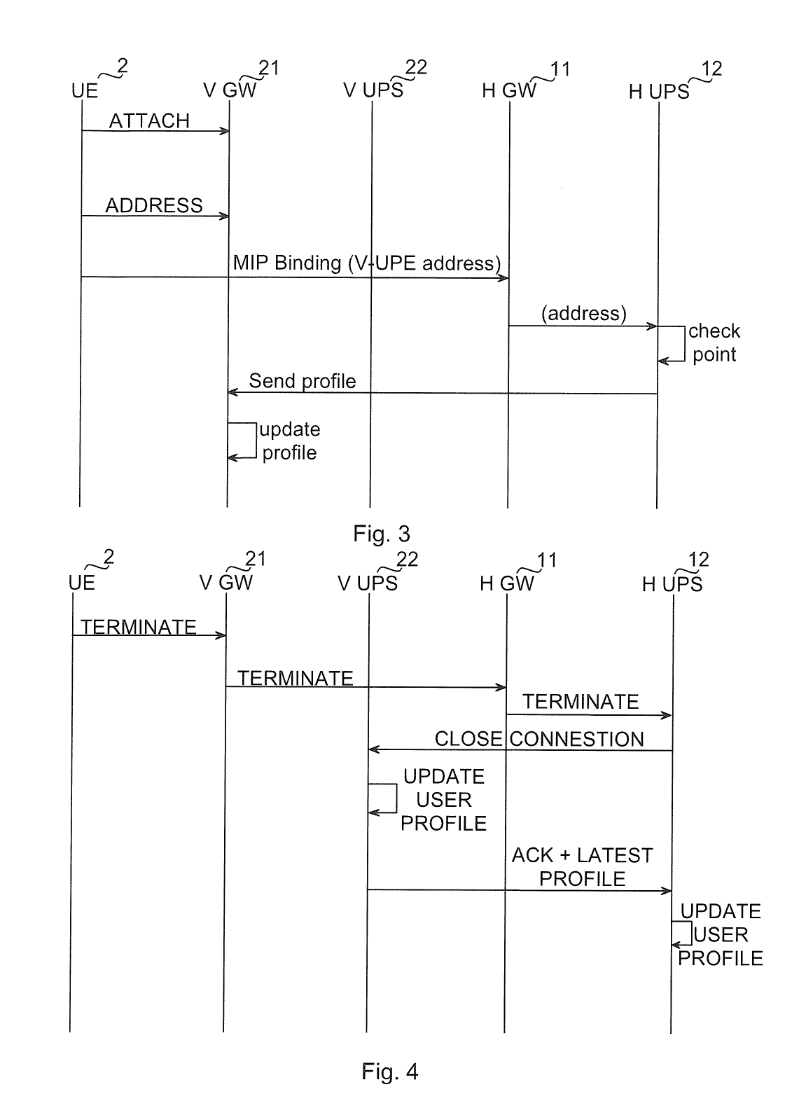

FIG. 3 is a sequence diagram illustrating communication between entities of FIG. 2 upon access request to the visited network 20. First, an attachment procedure is made between the user equipment 2 and the visited gateway server 21. The visited gateway server 21 sends in response an address pointing to the visited user profile server 22. A MIP binding procedure is performed between the user equipment 2 and the home gateway server 11, the signaling including the address (unique identifier) to the visited user profile server 22. The home gateway server 11 provides the home user profile server 12 the address to the visited user profile server 22. The home user profile server 12 creates a user profile based on e.g. policies and user consent. By basing the user profile on user preferences that the user has given his/her consent to, his/her integrity can be maintained. The exchange of user profiles may now be effectuated between the home and visited user profile servers 12, 22. The user profile may be updated in real time in the visited user profile server 22 as the user is roaming in the visited network 20.

There is no need to assign an IP address prior to the authentication procedure, and the implementation is independent of the access control protocol used for the authentication. The interaction between the user profile servers 12, 22 starts first after the IP sessions setup in both home network 10 and visited network 20, respectively, and use is made of policy control architecture. This means that there is a need for more signaling before initiation of the interaction between the user profile servers 12, 22 and the exchange of user profiles is effectuated after the MIP establishment is acknowledged by the concerned agent 14, 24.

MIP tunneling procedures and protocols may be used to carry the identifier, e.g. an address, to the visited user profile server 22 in early stages to enable a short term user profile creation according to policies that can be executed in line with the MIP tunneling procedure.

FIG. 4 is a sequence diagram illustrating communication between the entities of FIG. 2 at termination of access to the visited network 20. The user equipment 2 transmits a termination message to the visited gateway server 21. A conventional termination procedure is performed, comprising the visited gateway server 21 sending a termination message to the home gateway server 11. The home gateway server 11 in turn sends a termination message to the home user profile server 12, which sends a close connection message to the visited gateway server 21. The visited user profile server updates the user profile with the most recent user preferences and sends the user profile to the home user profile server 12, thus terminating the exchange of user profiles. The home user profile server 12 updates its database with the user profile obtained. The home user profile server 12 is updated with user preferences in real time based on user's activities in the visited network 20.

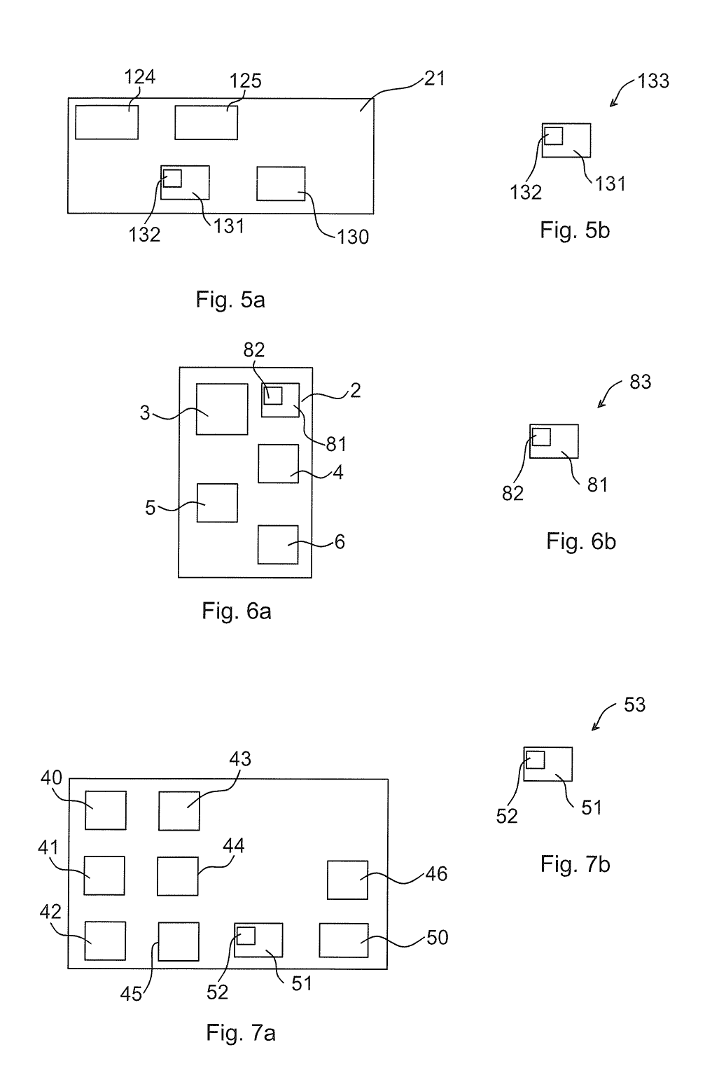

The visited gateway server 21 in the communication system 1 will be described next with reference to FIGS. 5a and 5b. The visited gateway server 21 comprises receiving circuitry 124 for receiving a user identification from a user equipment 2, and transmitting circuitry 125, which can be circuitry conventionally used.

The visited gateway server 21 is configured to transmit, by means of the transmitting circuitry 125, an identifier of the visited user profile server 22 to the user equipment 2 in response to receiving, by means of the receiving circuitry 124, the user identification. The user equipment 2 is thus able to convey the identifier of the visited user profile server 22 to the home user profile server 12, whereby the visited user profile server 22 and the home user profile server 12 are able to initiate user profiles exchange.

The above can be implemented by a computer program 132 comprising computer program code which, when run on the visited gateway server 21 causes the visited gateway server 21 to receive a user identification from a user equipment 2 requesting access to the visited network 20; and to transmit, in response to receiving the user identification, an identifier of the visited user profile server 22 to the user equipment 2 for conveyance by the user equipment 2 to the home user profile server 12. In particular, the computer program may be run on a processor 130 of the visited gateway server 21 with associated program memory including computer program code for performing the functionality.

In FIG. 5b, a computer program product 133 is illustrated comprising the computer program 132 and computer readable means 131 on which the computer program 132 is stored. Such computer readable means 131 may for example be in the form of a data carrier, like a CD ROM disc, a memory stick or a DVD disc, which will implement the function of the above-described units when being loaded into a computer.

The user equipment 2 for use in the communication system 1 will be described next with reference to FIGS. 6a and 6b. The user equipment 2 comprises a first processor 3 configured to request access to the visited network 20 utilizing access circuitry 4; and to receive, by means of first receiving circuitry 5 and in response to the request, from a visited gateway server 21 of the visited network 20, an identifier of a visited user profile server 22; and to convey, using first transmitting circuitry 6, the identifier of the visited user profile server 22 to the home user profile server 12.

The above can be implemented by a computer program 82 comprising computer program code which, when run on the first processor 3 causes the user equipment perform the above described functionality. In particular, the first processor 3 with associated program memory including computer program code performs the desired functionality.

In FIG. 6b, a computer program product 83 is illustrated comprising the computer program 82 and computer readable means 81 on which the computer program 82 is stored. Such computer readable means 81 may for example be in the form of a data carrier, like a CD ROM disc, a memory stick or a DVD disc, which will implement the function of the above-described units when being loaded into a computer or the first processor 3.

The visited user profile server 22 will be described next with reference to FIGS. 7a and 7b. The visited user profile server 22 comprises first receiving circuitry 40 configured to receive from the home user profile server 12 a user profile for a user visiting the visited network 20, first processing circuitry 41 configured to create a temporary user profile for the user based on the user profile received by means of the first receiving circuitry 40, and second processing circuitry 42 configured to update the temporary user profile with new user profile preferences obtained while the user equipment roams in the visited network 20. The first and second processing circuitry 41, 42 may be part of a single processor and the first receiving circuitry 40 may be conventional circuitry for receiving signals.

In one embodiment, the visited user profile server 22 further comprises second receiving circuitry 43 configured to receive a close connection message; third processing circuitry 44 configured to update the temporary user profile in the visited user profile server 22, the updating comprising new user profile preferences; first transmitting circuitry 45 configured to transmit to the home user profile server 12 the updated user profile.

The visited user profile server 22 may be provided with a processor with associated program memory including computer program code for performing the functionality of the various circuitries mentioned above. It should be realized that the functions described may also be provided in the form of the above mentioned hardware, like for instance in the form of ASIC circuits. The computer program code may be provided on a computer readable means, for instance in the form of a data carrier, like a CD ROM disc, a memory stick or a DVD disc, which will implement the function of the above-described units of the communication aspect investigating device when being loaded into a computer.

In particular, a computer program 52 for enabling the above functions may be provided. The computer program 52 comprises computer program code which, when run on the visited user profile server 22, e.g. a processor 50 therein, causes the visited user profile server 22 to: receive from the home user profile server 12 a user profile for a user visiting the visited network 20; create a temporary user profile for the user based on the received user profile, and update the temporary user profile with new user profile preferences obtained while the user roams in the visited network 20.

The computer program 52 may further comprise computer program code which, when run on the visited user profile server 22, e.g. in the processor 50, causes the visited user profile server 22 to: receive a close connection message; update the temporary user profile in the visited user profile server 22, the updating comprising latest user profile preferences; transmit to the home user profile server 12 the updated user profile. The program code can thus also be provided as a pure computer program. This computer program would then include computer program modules, which include computer program instructions that implement the functionality of the circuitry. This may be downloaded from a server, for instance via the Internet or via a point-to-point connection.

In an embodiment, illustrated in FIG. 7b, a computer program product 53 is provided comprising the computer program 52 and a computer readable means 51 on which the computer program 52 is stored.

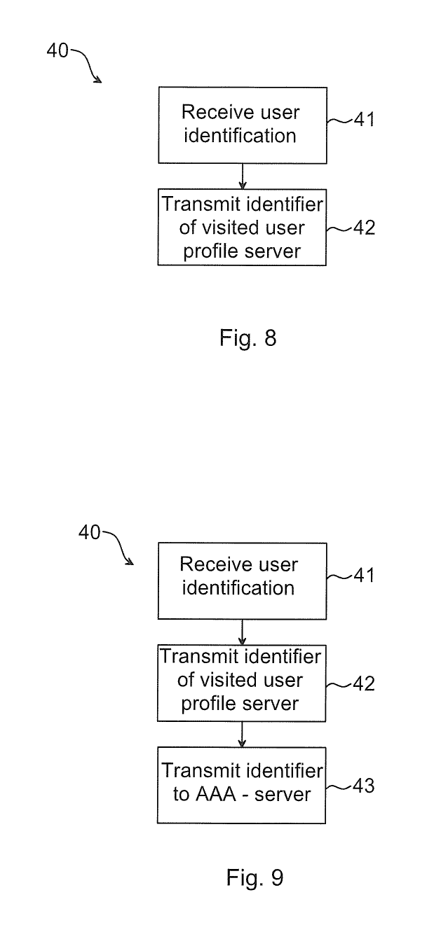

With reference to FIG. 8, a method 40 in the visited gateway server 21 in the communication system 1 is described. The method 40 comprises the first step of receiving 41 a user's identification from the user equipment 2 that is requesting access to the visited network 20. The user identification may be a Mobile Subscriber Integrated Services Digital Network Number (MSISDN), by means of which a subscription, and thereby the subscriber (user), is uniquely identified. That is, a telephone number of the subscriber identification module (SIM) card in the user equipment 2 can be identified and thus the user. The International Mobile Subscriber Identity (IMSI), stored on a subscriber identification module (SIM) card, is a unique identification associated with the user of the user equipment 2. The MSISDN together with IMSI are two examples of user identification that can be used for identifying the subscriber.

The method 40 comprises the second step of transmitting 42, in response to the received user identification, an identifier of the visited user profile server 22 to the user equipment 2. The user equipment 2 may then convey the identifier of the visited user profile server 22 to the home user profile server 12, thereby enabling the exchange of user profiles.

The identifier of the visited user profile server 22 comprises a unique identifier pointing to the visited user profile server 22, and may for example be a domain name address or Internet protocol address.

In one embodiment, illustrated in FIG. 9, the method 40 comprises the step of transmitting 43 the identifier of the visited user profile server 22 to the authentication, authorization and accounting proxy 29 of the visited network. The AAA proxy 29, described earlier, is thereby able to convey the identifier of the visited user profile server 22 to the authentication, authorization and accounting server 19 of the home network 10.

In the method 40, the step of receiving a user identification from the user equipment 2 may be performed during a procedure for initiating, by the user equipment 2, a new access to the visiting network 20, as was described earlier with reference to FIG. 2.

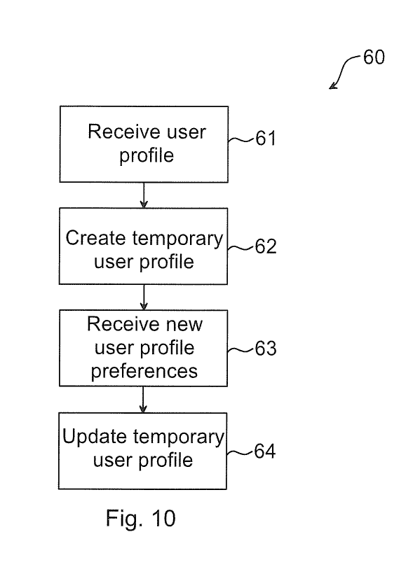

With reference to FIG. 10, a method 60 in the visited user profile server 22 is described. The method 60 comprises a step of receiving 61 from the home user profile server 12 a user profile for a user visiting the visited network 20. The method 60 comprises a step of creating 62 a temporary user profile for the user based on the received user profile. The method 60 comprises a step of receiving 63 new user profile preferences for the user obtained while the user roams in the visited network 20. The method 60 comprises a step of updating 64 the temporary user profile with the new user profile preferences.

The received user profile may be based on for instance a pre-configured policy, a service level agreement between the home network 10 and the visited network 20, user profile information allowed by the user and/or subscription data of the user.

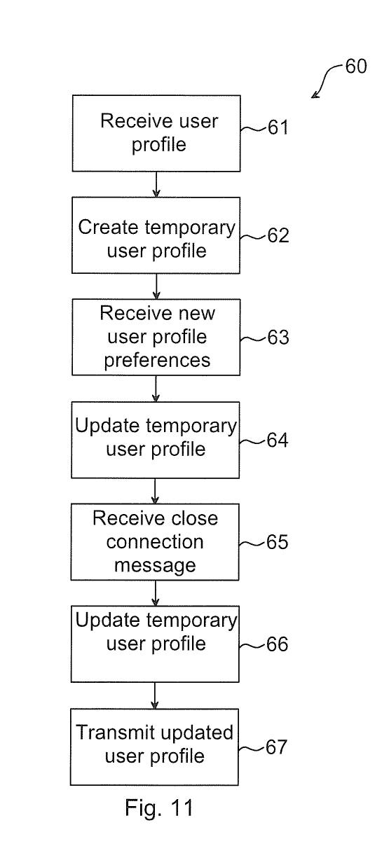

In one embodiment, illustrated in FIG. 11, the method 60 comprises the further steps of receiving 65 a close connection message; updating 66, in response to the close connection message, the temporary user profile in the visited user profile server 22, the updating comprising new user profile preferences; and transmitting 67 to the home user profile server 12 the updated user profile.

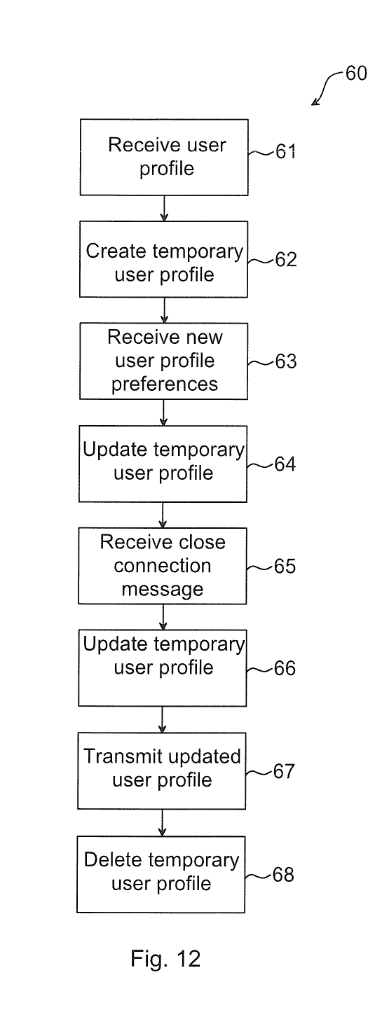

In one embodiment, illustrated in FIG. 12, the method 60 comprises the further step of receiving, after transmitting to the home user profile server 12 the updated user profile, deleting 68 the temporary user profile for the user. There is no need for the roaming partner, i.e. the operator of the visited network 20, to keep or update data about the user profile servers of each network included in a roaming agreement. The data needed to exchange user profiles is easily conveyed when needed. Further, the temporary user profiles may be deleted from the visited user profile server 22 once the user leaves the visited network 20.

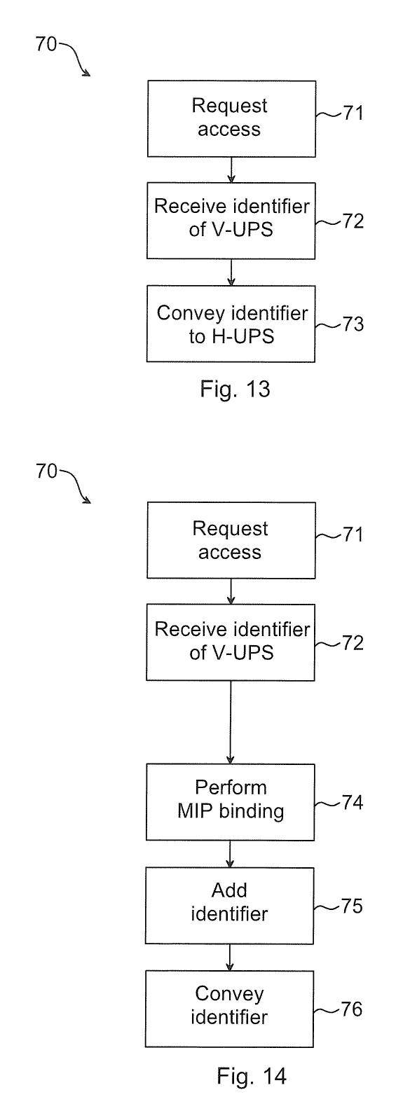

With reference to FIG. 13, a method 70 in the user equipment 2, described earlier with reference to FIGS. 6a and 6b, is described. The method 70 comprises a step of requesting 71 access to the visited network. The method 70 comprises a step of receiving 72, in response to the request, from a visited gateway server 21 of the visited network 20, an identifier of a visited user profile server 22. The method 70 comprises a step of conveying 73 the identifier of the visited user profile server 22 to the home user profile server 12.

In one embodiment, illustrated in FIG. 14, the step of conveying the identifier of the visited user profile server comprises performing 74 in a mobile internet protocol, MIP, registration or binding. In particular, for IP version 4 (IPv4), a registration request message is used for adding the identifier of the visited user profile server 22, and for IP version 6 (IPv6), a binding message is used for adding the identifier of the visited user profile server 22.

The step of conveying the identifier of the visited user profile server 22 further comprises adding 75 in the MIP registration or binding an identifier of the visited user profile server 22, and conveying 76 the identifier of the visited user profile server 22 to the home user profile server 12. The identifier of the visited user profile server 22 is thus carried from the visiting network 20 to the home gateway server 11 in a message depending on the IP version used by the user equipment. In implementing the invention, there is no need to introduce impact on entities of the MIP architecture, as extensions to the existing binding or registration request are used.

1-25. (canceled)

26. A method in a visited gateway server in a communication system comprising a home network and a visited network, for enabling exchange of user profiles between a visited user profile server of the visited network and a home user profile server of the home network, the method comprising:
receiving a user identification from a user equipment requesting access to the visited network; and
transmitting, in response to received user identification, an identifier of the visited user profile server to the user equipment for conveyance by the user equipment to the home user profile server, thereby enabling the exchange of user profiles.

27. The method as claimed in claim 26, comprising the step of:
transmitting the identifier of the visited user profile server to an authentication, authorization and accounting proxy of the visited network, which proxy thereby is able to convey the identifier of the visited user profile server to an authentication, authorization and accounting server of the home network.

28. The method as claimed in claim 26, wherein the step of receiving a user identification from the user equipment is performed during a procedure for initiating, by the user equipment, a new access to the visiting network.

29. The method as claimed in claim 26, wherein the identifier of the visited user profile server comprises a unique identifier pointing to the visited user profile server.

30. The method as claimed in claim 29, wherein the unique identifier comprises a domain name address or Internet protocol address.

31. A visited gateway server in a communication system comprising a home network and a visited network for enabling exchange of user profiles between a visited user profile server of the visited network and a home user profile server of the home network, comprising:
receiving circuitry for receiving a user identification from a user equipment, and transmitting circuitry; and
wherein the visited gateway server is configured to transmit, by means of the transmitting circuitry, an identifier of the visited user profile server to the user equipment in response to receiving, by means of the receiving circuitry, the user identification, for conveyance by the user equipment to the home user profile server, whereby the visited user profile server and the home user profile server are able to initiate user profiles exchange.

32. A computer readable medium storing a computer program for enabling, in a communication system comprising a home network and a visited network, exchange of user profiles between a visited user profile server of the visited network and a home user profile server of the home network, the computer program comprising computer program code which, when run on a visited gateway server of the visited network, causes the visited gateway server to:
receive a user identification from a user equipment requesting access to the visited network; and
transmit, in response to receiving the user identification, an identifier of the visited user profile server to the user equipment for conveyance by the user equipment to the home user profile server, whereby the visited user profile server and the home user profile server are able to exchange user profiles.

33. A method in a visited user profile server of a communication system comprising a home network and a visited network for enabling exchange of user profiles between a home user profile server of the home network and a visited user profile server of the visited network, the method comprising:
receiving from the home user profile server a user profile for a user visiting the visited network;
creating a temporary user profile for the user based on the received user profile;
receiving new user profile preferences for the user obtained while the user roams in the visited network; and
updating the temporary user profile with the new user profile preferences.

34. The method as claimed in claim 33, wherein the received user profile is based on one or more of: a pre-configured policy, a service level agreement between the home network and the visited network, user profile information allowed by the user, and subscription data of the user.

35. The method as claimed in claim 33, comprising the further steps of:
receiving a close connection message;
updating, in response to the close connection message, the temporary user profile in the visited user profile server, the updating comprising new user profile preferences; and
transmitting to the home user profile server the updated user profile.

36. The method as claimed in claim 35, comprising the step of, after transmitting the updated user profile to the home user profile server, deleting the temporary user profile for the user.

37. A visited user profile server of a communication system comprising a home network and a visited network, for enabling exchange of user profile preferences between a home user profile server of the home network and a visited user profile server of the visited network, the visited user profile server comprising:
first receiving circuitry configured to receive from the home user profile server a user profile for a user visiting the visited network;
first processing circuitry configured to create a temporary user profile for the user based on the user profile received by means of the first receiving circuitry; and
second processing circuitry configured to update the temporary user profile with new user profile preferences obtained while the user equipment roams in the visited network.

38. The visited user profile server as claimed in claim 37, further comprising:
second receiving circuitry configured to receive a close connection message;
third processing circuitry configured to update the temporary user profile in the visited user profile server, the updating comprising new user profile preferences; and
first transmitting circuitry configured to transmit the updated user profile to the home user profile server.

39. A computer readable medium storing a computer program for enabling, in a communication system comprising a home network and a visited network, exchange of user profiles between a visited user profile server of the visited network and a home user profile server of the home network, the computer program comprising computer program code which, when run on the visited user profile server of the visited network, causes the visited user profile server to:
receive from the home user profile server a user profile for a user visiting the visited network;
create a temporary user profile for the user based on the received user profile; and
update the temporary user profile with new user profile preferences obtained while the user roams in the visited network.

40. The computer program as claimed in claim 39, further comprising computer program code which, when run on the visited user profile server of the visited network, causes the visited user profile server to:
receive a close connection message;
update the temporary user profile in the visited user profile server, the updating comprising latest user profile preferences; and
transmit the updated user profile to the home user profile server.

41. A method in a user equipment of a communication system comprising a home network and a visited network for enabling exchange of user profiles between a home user profile server of the home network and a visited user profile server of the visited network, the method comprising:
requesting access to the visited network;
receiving, in response to the request, from a visited gateway server of the visited network, an identifier of a visited user profile server; and
conveying the identifier of the visited user profile server to the home user profile server.

42. The method as claimed in claim 41, wherein the step of conveying the identifier of the visited user profile server comprises:
performing a mobile internet protocol (MIP) registration or binding;
adding in the MIP registration or binding an identifier of the visited user profile server; and
conveying the identifier of the visited user profile server to the home user profile server.

43. The method as claimed in claim 41, wherein the step of conveying the identifier of the visited user profile server comprises adding in a registration or binding request message the identifier of the visited user profile server.

44. The method as claimed in claim 41, wherein the identifier of the visited user profile server comprises a unique identifier pointing to the visited user profile server.

45. The method as claimed in claim 44, wherein the unique identifier comprises a domain name address or Internet protocol address.

46. A user equipment of a communication system comprising a home network and a visited network, for enabling exchange of user profiles between a home user profile server of the home network and a visited user profile server of the visited network, the user equipment comprising a first processor configured to:
request access to the visited network utilizing access circuitry;
receive, by means of first receiving circuitry and in response to the request, from a visited gateway server of the visited network, an identifier of a visited user profile server; and
convey, using first transmitting circuitry, the identifier of the visited user profile server to the home user profile server.

47. A computer readable medium storing a computer program for enabling in a communication system comprising a home network and a visited network, the exchange of user profiles between a visited user profile server of the visited network and a home user profile server of the home network, the computer program comprising computer program code which, when run on a user equipment, causes the user equipment to:
